(19) United States
(12) Patent Application Publication
(10) Pub. No.: US 2026/0175600 A1
(43) Pub. Date: Jun. 25, 2026

(54) MEDIUM TRANSPORT DEVICE AND RECORDING APPARATUS

(71) Applicant: SEIKO EPSON CORPORATION, Tokyo (JP)

(72) Inventors: Makoto ISHIGURO, MATSUMOTO-SHI (JP); Kazutoshi MATSUZAKI, SHIOJIRI-SHI (JP)

(21) Appl. No.: 19/423,848

(22) Filed: Dec. 17, 2025

(30) Foreign Application Priority Data
Dec. 19, 2024 (JP) 2024-223805

(51) Int. Cl. B41J 13/00; B41J 11/00; B41J 13/03; B41J 13/076; B41J 13/10

(52) U.S. Cl. CPC B41J 13/0018; B41J 11/0095; B41J 13/03; B41J 13/076; B41J 13/103

(57) ABSTRACT

A medium transport device includes a separator, a first transport unit located downstream of the separator and configured to transport and stop the medium, a second transport unit located between the separator and the first transport unit, a control unit, and a length detection unit configured to detect a length of the medium along a transport direction. The separator includes a feeding part configured to transport the medium and a separation member configured to separate the medium by sandwiching the medium together with the feeding part. When the length of the medium is a first length, the control unit executes first separation control of driving the feeding part at the same speed as the second transport unit based on the first length, and executes second separation control of driving the feeding part at a speed less than the second transport unit subsequently to the first separation control.

The present application is based on, and claims priority from JP Application Serial Number 2024-223805, filed Dec. 19, 2024, the disclosure of which is hereby incorporated by reference herein in its entirety.

### BACKGROUND

### 1. Technical Field

The present disclosure relates to a medium transport device and a recording apparatus.

### 2. Related Art

In the related art, a medium transport device that transports a medium, such as paper, is known. For example, JP-A-2001-148760 discloses a sheet transport device that separates and feeds stacked sheets one by one. In the device, the transmission of a driving force to a feeding part is released after the sheet to be fed passes through a separator.

JP-A-2001-148760 is an example of the related art.

However, the device disclosed in JP-A-2001-148760 may be difficult to prevent occurrence of damage to the sheets caused by collision between the sheets. Specifically, depending on an arrangement of the separator and a trailing end detection unit, and a method for specifying a trailing end position of the sheet, a leading end of the subsequent sheet may pass through the separator after the preceding sheet passes through the separator. In this case, when the transport of the preceding sheet is temporarily stopped to correct skew of a medium or adjust an arrival time to an image processing unit, the trailing end of the preceding sheet and the leading end of the subsequent sheet may collide with each other and damage the sheet. That is, there is a demand for a medium transport device that prevents damage to the medium.

### SUMMARY

A medium transport device includes: a separator configured to separate a medium; a first transport unit located downstream of the separator in a transport direction of the medium and configured to transport and stop the medium; a second transport unit located between the separator and the first transport unit in the transport direction and configured to transport the medium to the first transport unit; a control unit configured to control the separator and the second transport unit; and a length detection unit configured to detect a length of the medium along the transport direction, in which the separator includes a feeding part configured to transport the medium in the transport direction, and a separation member configured to separate the medium by sandwiching the medium together with the feeding part, and when the length of the medium is a first length, the control unit executes first separation control of driving the feeding part at a same speed as a speed of the second transport unit based on the first length, and executes second separation control of driving the feeding part at a speed less than the speed of the second transport unit subsequently to the first separation control.

A recording apparatus includes the medium transport device and a recording unit configured to perform recording on the medium transported by the medium transport device.

### BRIEF DESCRIPTION OF THE DRAWINGS

FIG. 1 is a schematic diagram illustrating a configuration of a recording apparatus according to an embodiment.

FIG. 2 is a schematic diagram illustrating a configuration of a medium transport device.

FIG. 3 is a cross-sectional perspective view illustrating a configuration of a paper feed tray and a hopper.

FIG. 4 is a schematic diagram illustrating an arrangement of the hopper, a bundle of media, and the like with respect to a separator.

FIG. 5 is a schematic diagram illustrating a process of transporting the medium.

FIG. 6 is a schematic diagram illustrating the process of transporting the medium.

FIG. 7 is a schematic diagram illustrating a state where media are in contact with each other.

FIG. 8 is a schematic diagram illustrating an arrangement and an operation of a step member.

FIG. 9 is a schematic diagram illustrating a configuration of a medium transport device in the related art according to a comparative example.

FIG. 10 is a schematic diagram illustrating a method for controlling the medium transport device in the related art.

FIG. 11 is a schematic diagram illustrating a state of collision between media.

FIG. 12 is a schematic diagram illustrating a state after collision of media.

FIG. 13 is a schematic diagram illustrating a mechanism of occurrence of a transport failure in the medium transport device in the related art.

FIG. 14 is a schematic diagram illustrating a mechanism of occurrence of a transport failure in the medium transport device in the related art.

### DESCRIPTION OF EMBODIMENTS

In the embodiment described below, a medium transport device 100 that transports plain paper or the like and a recording apparatus 1 including the medium transport device 100 will be described as an example with reference to the drawings. The recording apparatus 1 is an inkjet printer. The recording apparatus according to the present disclosure is not limited to an inkjet printer. The medium transport device according to the present disclosure is not limited to being mounted on the recording apparatus, and is also applicable as an automatic document feeder mounted on a scanner, a copier, or the like.

In each of the following drawings, X, Y, and Z axes, and A and B axes, which are coordinate axes perpendicular to one another, are given as necessary, a direction indicated by an arrow is defined as a +direction, and a direction opposite to the +direction is defined as a −direction. The A axis and the B axis are orthogonal to the X axis and intersect with the Y axis and the Z axis. The +A direction is a direction in which a line head 40 to be described later approaches a transport belt 31. The +B direction is a transport direction of a medium P in a recording region between the line head 40 and the transport belt 31.

When the recording apparatus 1 is placed on a horizontal surface such as a floor, the −Z direction is a vertical direction. The +Z direction may be referred to as an upward direction, and the −Z direction may be referred to as a downward direction. For convenience of illustration, a size of each member is different from an actual size.

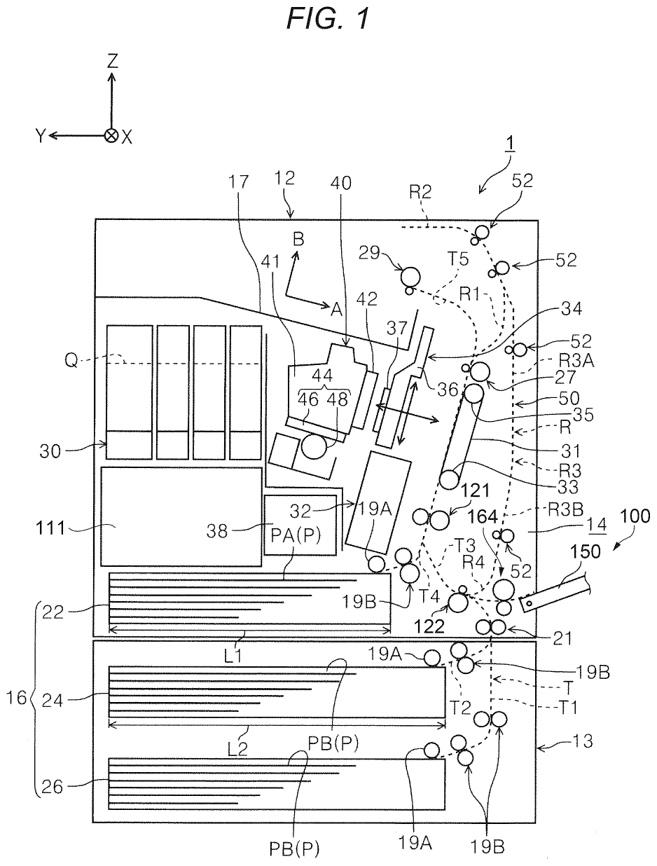

The recording apparatus 1 illustrated in FIG. 1 performs recording by discharging ink Q, which is a liquid, onto the medium P, which is paper such as plain paper. In the recording apparatus 1, the medium P is transported through a transport path T indicated by a broken line. The transport path T is curved at each portion of the recording apparatus 1, and similarly, a transport direction is not uniform. In the transport path T, a side on which the medium P is supplied, such as a paper feed tray 150, is referred to as an upstream side, and a side on which the medium P on which recording is performed faces a discharge tray 17 is referred to as a downstream side.

In the following description, the transport direction of the medium P may be simply referred to as a transport direction. In the transport direction, a downstream end portion of the medium P is referred to as a leading end, and an upstream end portion of the medium P is referred to as a trailing end.

In the recording apparatus 1, as the medium P, media PA and PB having different lengths along the transport direction can be used for recording. The length of the medium PA along the transport direction is less than the length of the medium PB along the transport direction. In the following description, a length of the medium P or the like along the transport direction may be simply referred to as a length of the medium P or the like.

The recording apparatus 1 includes a main body unit 12 and an extension unit 13 disposed below the main body unit 12. Specifically, the recording apparatus 1 includes a paper cassette unit 16, the line head 40, and a reversing unit 50. The recording apparatus 1 further includes an ink supply unit 30, a cap unit 32, a wiper unit 34, a waste liquid tank 38, and the medium transport device 100 including the paper feed tray 150 and a control unit 111.

The main body unit 12 includes a housing serving as an outer shell. The discharge tray 17 is provided in an upper portion of the main body unit 12 in the +Y direction. The main body unit 12 and the extension unit 13 are provided with the paper cassette unit 16. An opening 14 that opens in the −Y direction is formed at an end portion of the main body unit 12 in the −Y direction. A part of the transport path T is exposed to an outside by opening the opening 14.

The extension unit 13 includes a housing serving as an outer shell. The extension unit 13 is detachable from the main body unit 12. An upper end portion of the extension unit 13 and a lower end portion of the main body unit 12 are coupled to each other. Accordingly, the medium P can be transported from the extension unit 13 to the main body unit 12.

The medium P on which recording is performed by the line head 40 is discharged and stacked on the discharge tray 17. The discharge tray 17 extends along the A axis. In the discharge tray 17, end portions of a plurality of media P in the +A direction are aligned along the B axis.

The paper cassette unit 16 accommodates the medium P. The paper cassette unit 16 includes a first cassette 22 housed in the main body unit 12, and a second cassette 24 and a third cassette 26 housed in the extension unit 13.

The first cassette 22 accommodates a medium PA. The first cassette 22 has a substantially rectangular parallelepiped box shape and opens upward. The first cassette 22 has a first length L1 along the Y axis. A length of the medium PA is equal to or less than the L1. The medium P accommodated in the first cassette 22 is fed to the transport path T by rotation of a pickup roller 19A and a roller pair 19B.

The second cassette 24 accommodates a medium PB. The second cassette 24 is located below the first cassette 22. The second cassette 24 has a substantially rectangular parallelepiped box shape and opens upward. The second cassette 24 has a second length L2 along the Y axis. The second length L2 is larger than the first length L1. A length of the medium PB is equal to or less than the L2. The length of the medium PB may be equal to or larger than the L1. In a direction along the X axis, a length of the second cassette 24 is larger than a length of the first cassette 22. The medium P accommodated in the second cassette 24 is fed to the transport path T via a path T2 by the rotation of the pickup roller 19A and the roller pair 19B.

The third cassette 26 is located below the second cassette 24 in the extension unit 13. The third cassette 26 has the same configuration as the second cassette 24 except that the arrangement is different. Therefore, the description of the third cassette 26 will be omitted.

The ink supply unit 30 supplies the ink Q as a liquid to the line head 40. The ink supply unit 30 is a container that contains the ink Q. A plurality of ink supply units 30 are disposed according to types of the ink Q of each color exhibiting colors such as black, cyan, magenta, and yellow.

In the cap unit 32, a maintenance operation of the line head 40 is performed. The cap unit 32 is a box-shaped member that opens in the −A direction. The cap unit 32 is driven by a drive mechanism (not illustrated) and can reciprocate along the B axis. When performing maintenance of the line head 40, the cap unit 32 moves in the +B direction, covers a discharge unit 42 of the line head 40, and suctions the ink Q. The cap unit 32 retracts in the −B direction when a recording operation is performed by the line head 40.

The wiper unit 34 includes a unit main body 36 and a wiper blade 37. The unit main body 36 collects the ink Q. The wiper blade 37 is provided on the unit main body 36. The wiper blade 37 wipes off the ink Q attached to the discharge unit 42. The wiper unit 34 is driven by a driving mechanism (not illustrated) and reciprocates along the X axis. When performing the maintenance of the line head 40, the wiper unit 34 moves in the +X direction and collects the ink Q by sliding on a surface of the discharge unit 42. The wiper unit 34 retracts to a home position in the −X direction when the recording operation is performed by the line head 40.

The waste liquid tank 38 is provided substantially at a center of the main body unit 12 in a direction along the Y axis and a direction along the Z axis. The waste liquid tank 38 is detachable from the main body unit 12. The waste liquid tank 38 stores the ink Q collected by the cap unit 32 and the ink Q collected by the wiper unit 34.

The control unit 111 is disposed above the first cassette 22 in the main body unit 12. The control unit 111 includes a central processing unit (CPU), a system bus, a read only memory (ROM), a random access memory (RAM), and the like. The control unit 111 is electrically coupled to each configuration of the medium transport device 100 and the recording apparatus 1, and integrally controls operations of the recording apparatus 1 including the medium transport device 100. In particular, the control unit 111 controls a separator 164 and a second transport unit 122 to be described later. The control unit 111 may control other rollers to be described later. The medium transport device 100 and the recording apparatus 1 may be operated by an information device such as a personal computer via the control unit 111. The recording apparatus 1 may include another control unit capable of cooperating with the control unit 111. The arrangement of the control unit 111 is not limited to the above description.

The line head 40 performs recording by discharging the ink Q, which is a liquid, onto the medium P transported by the medium transport device 100 or the like. The line head 40 is an example of a recording unit of the present disclosure. The line head 40 is located at a home position before starting recording. The line head 40 is located above the paper cassette unit 16 and the waste liquid tank 38 at the home position. The line head 40 is driven by a movement mechanism unit 44 and can move in the +A direction and the −A direction.

Specifically, the line head 40 includes a carriage 41 driven by the movement mechanism unit 44, and the discharge unit 42 supported by the carriage 41.

The discharge unit 42 is an inkjet head and is disposed with a plurality of nozzles (not illustrated) on a surface facing the +A direction. The ink Q in the ink supply unit 30 is individually supplied to the discharge unit 42 via a pipe (not illustrated) or the like. The discharge unit 42 discharges the ink Q from the plurality of nozzles toward the medium P.

The discharge unit 42 includes a piezoelectric element as an actuator which is a drive unit. As the drive unit, for example, electromechanical conversion elements that displace vibrating plates as the actuators with electrostatic adsorption, or electrothermal conversion elements that discharge the ink as droplets using air bubbles generated by heating may be used.

The movement mechanism unit 44 includes a rack portion 46, a pinion 48, and a motor (not illustrated). The rack portion 46 is attached to a substantially lower bottom portion of the carriage 41. The rack portion 46 has a plurality of tooth portions (not illustrated). The pinion 48 is driven by the motor to rotate in a forward direction or a reverse direction. A plurality of tooth portions (not illustrated) that mesh with the plurality of tooth portions of the rack portion 46 are formed at an outer peripheral portion of the pinion 48.

The transport path T is a path along which the medium P is transported. The transport path T extends from the paper cassette unit 16 and the paper feed tray 150 to the discharge tray 17. The paper feed tray 150 is disposed to protrude substantially in the −Y direction from a surface of the main body unit 12 facing the −Y direction from below.

In the transport path T, the pickup rollers 19A, the roller pairs 19B, a reception roller pair 21, the separator 164, a first transport unit 121 that is a roller pair, a second transport unit 122 that is a roller pair, the transport belt 31, a driving roller 33, a driven roller 35, a roller pair 27, and a discharge roller pair 29 are disposed. Each roller pair is rotatable about a central axis along the X axis. The driving roller 33 and the driven roller 35 are disposed at an interval in the direction along the B axis, and are rotatable about a central axis along the X axis. Although details will be described later, the separator 164, the first transport unit 121, and the second transport unit 122 are included in the medium transport device 100, in addition to the above-described paper feed tray 150 and control unit 111.

The reception roller pair 21 is rotatably provided at a lower end portion of the main body unit 12 in the direction along the Z axis. The reception roller pair 21 receives the medium P transported from the extension unit 13. When viewed from the +Y direction, a part of the reception roller pair 21 and a part of the first cassette 22 overlap in the direction along the Z axis.

The transport belt 31 is stretched between the driving roller 33 and the driven roller 35. The transport belt 31 is disposed in the +A direction with respect to the line head 40. When the driving roller 33 is rotationally driven by a motor (not illustrated), the transport belt 31 circulates. The driven roller 35 rotates in conjunction with the circumferential movement of the transport belt 31. The medium P is transported in the +B direction by the circumferential movement of the transport belt 31 in a state of being in contact with an outer peripheral surface of the transport belt 31.

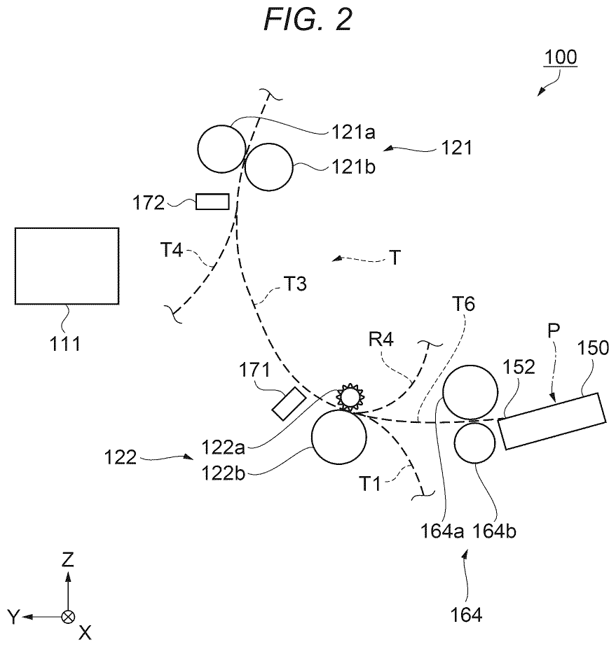

The transport path T includes paths T1, T2, T3, T4, T5, and T6 (FIG. 2). The path T1 extends from a position of an end portion of the third cassette 26 in the −Y direction to the second transport unit 122. The path T2 extends from a position of an end portion of the second cassette 24 in the −Y direction toward a curved path R4 to be described later. The path T2 merges with the path T1 at a position upstream of the reception roller pair 21 in the path T1.

The path T3 extends from the second transport unit 122 to the first transport unit 121. The path T4 extends from a position of an end portion of the first cassette 22 in the −Y direction and merges with the path T3. The path T5 extends from the first transport unit 121 to the discharge roller pair 29 via the transport belt 31 and the roller pair 27.

The reversing unit 50 includes a reversing path R, four roller pairs 52, and a motor (not illustrated). The reversing unit 50 reverses the front and back of the medium P on which recording is performed by the line head 40, and feeds the medium P to the transport path T again.

The reversing path R is a path coupled to configurations upstream and downstream of the line head 40 in the transport path T. The reversing path R includes a branch path R1, a switchback path R2, an upstream path R3, and the curved path R4. The branch path R1 branches from the path T5 above the roller pair 27 and extends upward in the −Y direction. The switchback path R2 extends upward in the +Y direction from an upper end portion of the branch path R1.

The upstream path R3 is located upstream of the curved path R4 and downstream of the switchback path R2 in the transport direction of the medium P. The upstream path R3 includes a vertical path portion R3A and an inclined portion R3B. The vertical path portion R3A extends substantially linearly downward from a merging position of the branch path R1 and the switchback path R2.

The inclined portion R3B extends substantially linearly downward in the +Y direction from a position of a lower end portion of the vertical path portion R3A.

The curved path R4 is located downstream of the upstream path R3 in the transport direction of the medium P. Specifically, an upstream end of the curved path R4 is coupled to a lower end of the inclined portion R3B. The curved path R4 is curved to be convex downward when viewed from the −X direction. The curved path R4 merges with the path T3 at the second transport unit 122. The second transport unit 122 is disposed at a lower end portion of the curved path R4.

When performing recording on the medium P, the medium P is transported from the paper cassette unit 16 corresponding to the paths T1, T2, and T4 to the recording region, which is a position where the transport belt 31 and the line head 40 face each other. When performing recording on the medium P, the medium P is transported from the paper cassette unit 16 corresponding to the paths T1, T2, and T4 to a platen, which is a position where the transport belt 31 and the line head 40 face each other. The medium P may be supplied from the paper feed tray 150 to the second transport unit 122 via the separator 164. The path T6 and details of the supply of the medium P from the paper feed tray 150 will be described later.

The ink Q is attached to the medium P from the discharge unit 42 at a predetermined timing while the medium P is transported by the transport belt 31. Accordingly, images such as photographs, illustrations, and texts are recorded on the medium P. The medium P on which recording is performed is fed to the discharge tray 17 by the discharge roller pair 29.

When performing recording on both the front and back surfaces of the medium P, the medium P on which recording is performed on one surface is guided from the path T5 to the switchback path R2 via the branch path R1 of the reversing path R by a flap (not illustrated). The medium P is temporarily transported by the roller pair 52 to a position in the vicinity of an end portion of the switchback path R2, that is, an upper end portion of the main body unit 12. Thereafter, the medium P is transported downward in the switchback path R2, proceeds through the vertical path portion R3A, the inclined portion R3B, and the curved path R4 in order by the plurality of roller pairs 52 and reaches the second transport unit 122. Then, the medium P is transported from the path T3 to the platen.

At this time, the front and back of the medium P are reversed by passing through the reversing path R, and a surface of the medium P on which recording is not performed faces the line head 40. After recording is performed on the medium P by the line head 40, the medium P is discharged to the discharge tray 17 as in the case of performing recording on only one surface.

As illustrated in FIG. 2, the medium transport device 100 according to the embodiment includes the paper feed tray 150 as a placement unit, a hopper 152, the separator 164, the second transport unit 122, the first transport unit 121, sensing units 171 and 172, and the control unit 111. Although not illustrated, the medium transport device 100 further includes a first drive unit, a second drive unit, and a length detection unit.

The transport path T of the medium P from the paper feed tray 150 to the separator 164 is the path T6. The medium transport device 100 supplies and transports the medium P from the paper feed tray 150 to the platen of the recording apparatus 1 through the path T6 and the path T3. The hopper 152, the separator 164, the second transport unit 122, and the first transport unit 121 are disposed in this order from upstream to downstream of the transport path T from the paper feed tray 150 to the first transport unit 121.

The paper feed tray 150 has a substantially box shape with an open top, and the plurality of media P are placed therein in a stacked state. The medium P is, for example, a cut sheet having, for example, an A size. The medium P is placed in the paper feed tray 150 with a longitudinal direction along the Y axis or the X axis.

The hopper 152 allows an end portion region in substantially the +Y direction of the medium P placed in the paper feed tray 150 to abut a feeding part 164a of the separator 164. The hopper 152 is disposed at an upstream end of the path T6 at an end portion of the paper feed tray 150 in the substantially +Y direction. In the direction along the X axis, a length of the hopper 152 is equal to or larger than a length of the medium P placed in the paper feed tray 150 and less than a length of the paper feed tray 150.

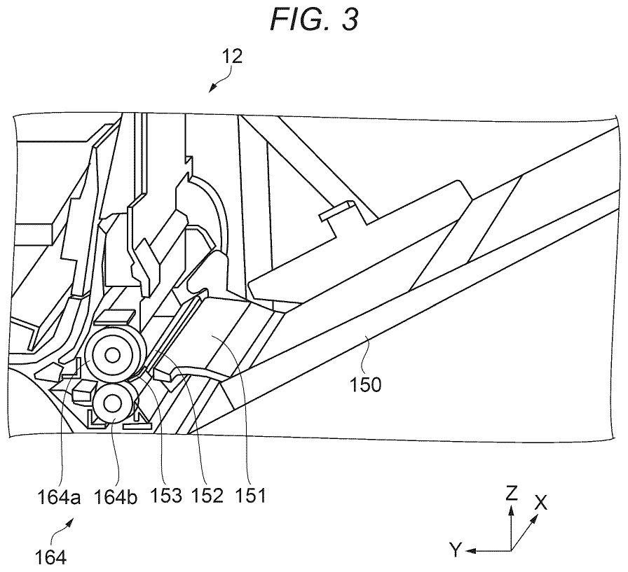

Here, as illustrated in FIG. 3, the hopper 152 is a substantially plate-shaped member elongated along the X axis. The hopper 152 is biased by a biasing member (not illustrated) and can be switched between a raised state and a lowered state. The hopper 152 illustrated in FIG. 3 is in the raised state.

To supply the medium P from the paper feed tray 150, an end portion of the medium P in the +Y direction is lifted substantially upward from the paper feed tray 150 in the raised state of the hopper 152. Accordingly, the end portion of the medium P in the +Y direction, that is, an end portion on a side close to the separator 164 rises and is pressed against the feeding part 164a.

A guide member 151 is disposed in the −Y direction with respect to the hopper 152. The guide member 151 is a slope that connects a step between the hopper 152 in the raised state and the paper feed tray 150. The guide member 151 is lifted in conjunction with the switching of the hopper 152 to the raised state, and sinks in conjunction with the switching to the lowered state. When the hopper 152 is in the raised state, the medium P is gently curved by the guide member 151 and lifted to the hopper 152.

Here, a pickup roller may be disposed between the separator 164 and the paper feed tray 150, and the medium P may be fed to the separator 164 via the pickup roller.

The hopper 152 includes a friction member 153. The friction member 153 is provided at a center of the hopper 152 in the direction along the X axis and at a position facing the feeding part 164a.

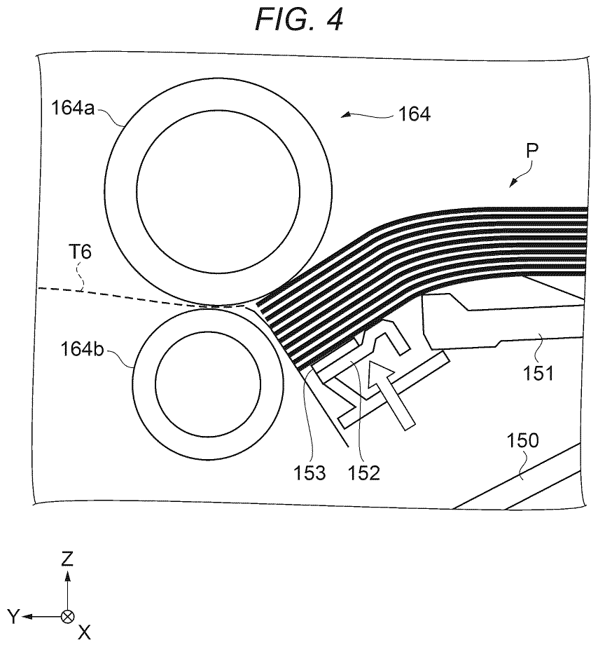

As illustrated in FIG. 4, the friction member 153 is in contact with the lowermost medium in a bundle of media P to prevent multi-feed of the media P. The friction member 153 has a substantially rectangular plate shape, and has a main surface facing a roller surface of the feeding part 164a. The friction member 153 includes, for example, a material having a relatively high coefficient of friction, such as a cork material. A coefficient of friction between the medium P and the friction member 153 is larger than a coefficient of friction between the media P. When there is no medium P in the paper feed tray 150 in the raised state of the hopper 152, the friction member 153 is pressed against the feeding part 164a by the biasing of the biasing member.

When there is a bundle of media P in the paper feed tray 150 in the raised state of the hopper 152, the uppermost medium P in the bundle of media P is pressed against the feeding part 164a, and the lowermost medium P in the bundle of media P is pressed against the friction member 153 by a reaction force. FIG. 4 illustrates a state where a position of a leading end of the bundle of media P is at a correct position with respect to the separator 164, in other words, at a normal position.

The separator 164 separates the plurality of media P. The separator 164 includes the feeding part 164a and a separation member 164b. The feeding part 164a transports the medium P in substantially the +Y direction, which is the transport direction. The separation member 164b separates the media P by sandwiching the medium P together with the feeding part 164a. Specifically, when the plurality of media P reach the separator 164, only the uppermost medium P is separated from the bundle of media P and is fed to the downstream path T6.

The feeding part 164a and the separation member 164b are each a substantially cylindrical roller, and are disposed in a pair in an up-down direction. The feeding part 164a is disposed above, and the separation member 164b is disposed below the feeding part 164a. The separation member 164b is biased upward by a biasing unit (not illustrated) and abuts the feeding part 164a. The feeding part 164a and the separation member 164b are each rotatable about a central axis along the X axis.

In the feeding part 164a and the separation member 164b, side surfaces, which are regions in contact with each other and are in contact with the medium P, are each formed of a member having a relatively high coefficient of friction, such as urethane resin or rubber. Accordingly, it is possible to separate and transport the plurality of media P.

When transporting the medium P, the feeding part 164a is driven by the second drive unit (not illustrated) and rotates clockwise when viewed from the −X direction. A speed at which the feeding part 164a is driven and rotated is variably controlled by the control unit 111.

The separation member 164b is a separation roller capable of switching between a driven state of being driven to rotate with respect to the rotation of the feeding part 164a, and a separation state of rotating in a direction opposite to that in the driven state. Specifically, the separation member 164b is a retard roller including a torque limiter. That is, the separator 164 employs an active retard system.

It is possible to prevent multi-feed of the media P by the active retard system. Specifically, when one medium P is fed from the separator 164, the rotation of the feeding part 164a is transmitted to the separation member 164b by a friction force between the feeding part 164a and the medium P and a friction force between the media P. The friction force of rotation transmitted to the separation member 164b exceeds an upper limit of the torque limiter of the separation member 164b. Therefore, the separation member 164b is in the driven state, is driven by the feeding part 164a, and rotates counterclockwise when viewed from the −X direction. Accordingly, one medium P is fed from the separator 164.

When two or more media P reach the separator 164, a plurality of media P are interposed between the feeding part 164a and the separation member 164b. Since a friction force when the media P slide is relatively small, the friction force of the rotation of the feeding part 164a is attenuated before reaching the separation member 164b. Therefore, the torque limiter of the separation member 164b does not exceed the upper limit, and the separation member 164b rotates in the direction opposite to that in the driven state. Accordingly, only one medium P in contact with the feeding part 164a is fed from the separator 164, and the second and subsequent media P are not fed from the separator 164, thereby preventing multi-feed.

The separation member 164b is not limited to a retard roller and may be a contact plate or a convex member in contact with the feeding part 164a.

The separator 164 further includes a switching unit (not illustrated). The switching unit is a clutch mechanism and can switch between a driving state where the feeding part 164a is driven and rotated and a disengaged state where the feeding part 164a is driven and rotated by the movement of the medium P. A driving force of the second drive unit is transmitted to the feeding part 164a in the driving state, and the driving force of the second drive unit is not transmitted in the disengaged state.

Returning to FIG. 2, the first transport unit 121 is provided downstream of the separator 164 in the transport direction of the medium P and at a position closest to the platen in the medium transport device 100. The second transport unit 122 is located between the separator 164 and the first transport unit 121 in the transport direction. In other words, the second transport unit 122 is disposed at a start point of the path T3, and the first transport unit 121 is disposed downstream of the path T3.

The first transport unit 121 and the second transport unit 122 are driven by the first drive unit. The first drive unit and the second drive unit are, for example, electric motors such as servo motors and stepping motors. Operations of the first drive unit and the second drive unit are controlled by the control unit 111, respectively.

The feeding part 164a is driven by the second drive unit while the first transport unit 121 and the second transport unit 122 are driven by the first drive unit. Therefore, it is easy to change a driving speed of the feeding part 164a. That is, a transport speed of the medium P by the feeding part 164a can be more easily changed than the transport speed of the medium P by the second transport unit 122. Since the first transport unit 121 and the second transport unit 122 have a common drive source, the medium transport device 100 can have a simpler configuration than a configuration including individual drive sources. The first transport unit 121, the second transport unit 122, and the feeding part 164a may be driven by a common drive source.

The second transport unit 122 includes a rotating body 122a and a transport roller 122b. The second transport unit 122 transports the medium P fed from the separator 164 to the first transport unit 121 by sandwiching the medium P between the rotating body 122a and the transport roller 122b.

Since the second transport unit 122 is disposed between the separator 164 and the first transport unit 121, in the medium transport device 100, a minimum value of a length of the medium P that can be transported is less than a length along the transport direction from the separator 164 to the first transport unit 121. Accordingly, since the number of applicable lengths of the medium P increases, usability can be improved. In addition, even when the medium P has a relatively short length, it is possible to prevent the collision between the media P and to alleviate the impact when the media P come into contact with each other by an action to be described later.

The rotating body 122a and the transport roller 122b are disposed in a pair in the up-down direction. The rotating body 122a is disposed above, and the transport roller 122b is disposed below the rotating body 122a. The rotating body 122a and the transport roller 122b are each rotatable about a central axis along the X axis.

The rotating body 122a is a so-called knurled roller and includes a plurality of protrusions protruding toward the medium P to be transported. Therefore, when the second transport unit 122 transports the medium P while sandwiching the medium P between the rotating body 122a and the transport roller 122b, the protrusions in the rotating body 122a come into contact with the medium P. The rotating body 122a rotates clockwise when viewed from the −X direction following the rotation of the transport roller 122b.

When performing recording on both the front and back surfaces of the medium P, a surface of the medium P on which recording is already performed is in contact with the rotating body 122a during recording. At this time, the rotating body 122a supports the surface of the medium P with the protrusions. That is, in the second transport unit 122, the protrusions of the rotating body 122a support the surface on which recording is performed. Therefore, the ink Q that is not completely dried is less likely to adhere to the rotating body 122a than in a configuration in which the surface is supported by a surface. Therefore, when the subsequent medium P is transported by the second transport unit 122, contamination of the subsequent medium P by the ink Q is prevented.

The transport roller 122b has a substantially cylindrical shape. The transport roller 122b is driven by the first drive unit and rotates counterclockwise when viewed from the −X direction.

A region corresponding to a side surface of the cylinder in the transport roller 122b is formed of a member having a relatively high coefficient of friction, such as urethane resin or rubber. Accordingly, it is possible to transport the medium P while sandwiching the medium P together with the rotating body 122a.

The first transport unit 121 includes a first roller 121a and a second roller 121b. The first roller 121a and the second roller 121b are disposed as a pair in a direction substantially along the Y axis. The first roller 121a is disposed in substantially the +Y direction, and the second roller 121b is disposed in contact with the first roller 121a in substantially the −Y direction of the first roller 121a. The first roller 121a and the second roller 121b are each rotatable about a central axis along the X axis.

The first transport unit 121 is a so-called registration roller, and can transport and stop the medium P. Specifically, when the medium P is transported, the first transport unit 121 transports the medium P fed from the second transport unit 122 downstream by sandwiching the medium P between the first roller 121a and the second roller 121b.

When the medium P transported along the path T3 is skewed or curved, correction is performed. Specifically, the first transport unit 121 is stopped, and the second transport unit 122 additionally transports the medium P by a predetermined amount. Accordingly, a leading end of the medium P in the transport direction abuts against the first transport unit 121 that stops rotating to form a loop, thereby eliminating skew or curving.

The first roller 121a and the second roller 121b each have a substantially cylindrical shape and are rotatable about a central axis along the X axis. In the first roller 121a and the second roller 121b, a region corresponding to a side surface of the cylinder is formed of a member having a relatively high coefficient of friction, such as urethane resin or rubber. Accordingly, it is possible to transport the medium P with the medium P sandwiched therebetween. The second roller 121b is driven by the first drive unit and rotates clockwise when viewed from the −X direction. The first roller 121a rotates counterclockwise when viewed from the −X direction following the rotation of the second roller 121b.

The sensing units 171 and 172 are disposed downstream of the second transport unit 122 in the transport direction. The sensing units 171 and 172 detect the presence or absence of the medium P in corresponding regions in the path T3, respectively. The sensing units 171 and 172 are, for example, non-contact optical sensors such as photosensors.

The sensing unit 171 is disposed near a side downstream of the second transport unit 122. The sensing unit 172 is disposed near a side upstream of the first transport unit 121. Sensing results by the sensing units 171 and 172 are transmitted to the control unit 111.

The length detection unit detects the length of the medium P along the transport direction. In the following description, the length of the medium P along the transport direction may be simply referred to as the length of the medium P. The length of the medium P is transmitted from the length detection unit to the control unit 111.

The length detection unit is, for example, the sensing units 171 and 172. At least one of the sensing units 171 and 172 detects the length of the medium P based on the transport speed of the medium P, a detection interval of the end portion, and the like. The length detection unit may be disposed separately from the sensing units 171 and 172. An input device of an operation panel provided in the recording apparatus 1 or an information device coupled to the recording apparatus 1 may be used as the length detection unit. That is, the recording apparatus 1 may detect the length of the medium P based on input information by using the devices described above as the length detection unit.

Hereinafter, a method for controlling the medium transport device 100 will be described. A method for controlling the medium transport device 100 described below relates to the transport of the medium P. First, a method for controlling a medium transport device 200 in the related art, which is a comparative example, and a problem that occurs will be described. The medium transport device 200 is obtained by changing the control method related to the transport of the medium P from the medium transport device 100 according to the embodiment. In drawings illustrating the medium transport device 200, the same reference numerals are applied to the same configurations as those of the medium transport device 100, and redundant description will be omitted. In the following description of drawings of the medium transport devices 100 and 200, unless otherwise specified, a state viewed from the −X direction will be described.

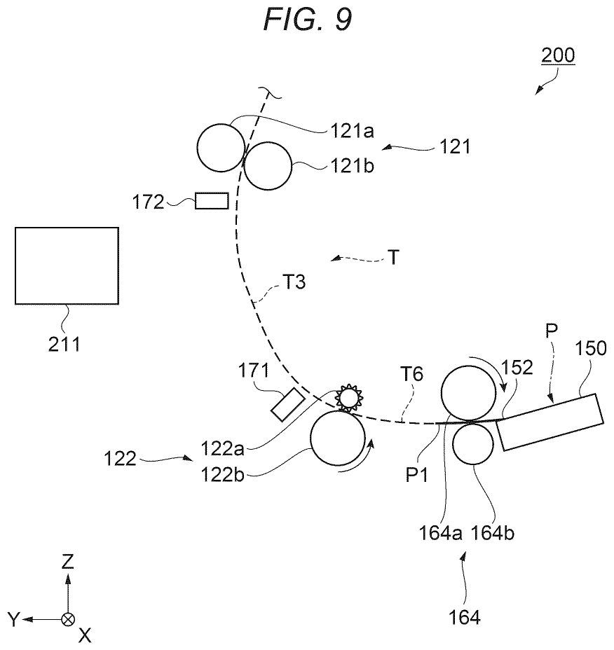

As illustrated in FIG. 9, the medium transport device 200 according to the comparative example includes a control unit 211. The control unit 211 is different from the control unit 111 of the medium transport device 100 in a control method related to the transport of the medium P. Other configurations of the control unit 211 are similar to those of the control unit 111. The control method by the control unit 211 is a control method in the related art, and a problem may occur.

When the medium transport device 200 supplies the medium P, first, a medium P1, which is the leading medium P, is fed from the paper feed tray 150 and transported through the path T6. At this time, until the medium P1 reaches the first transport unit 121, the separator 164 transports the medium P1 by a sum of the length of the medium P1 and an additional transport amount. Therefore, the medium P1 passes through the separator 164 completely. Accordingly, when subsequent transport or skew correction is performed, back tension is not applied to the medium P1. It is assumed that the length of the medium P1 and the length of a medium P2 to be described later are equal to each other and less than the distance from the first transport unit 121 to the separator 164 along the transport direction.

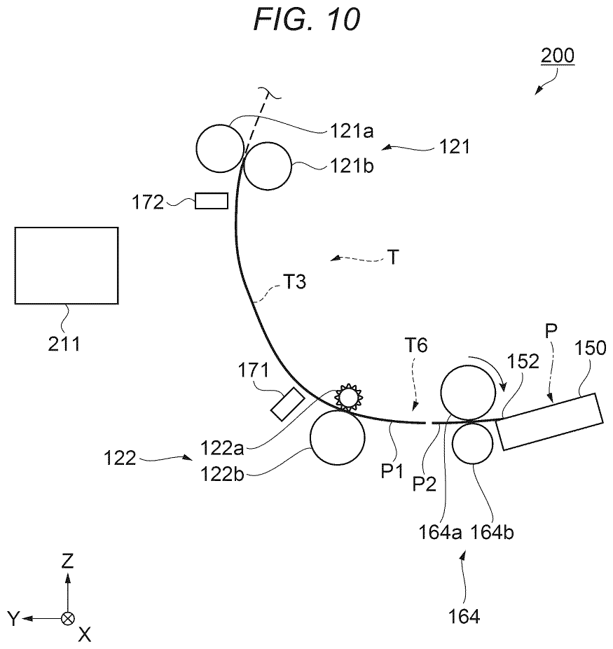

Next, as illustrated in FIG. 10, when there is the medium P2, which is the subsequent medium P following the medium P1, the separator 164 substantially brings the medium P2 into contact with the medium P1 and starts the transport after the medium P1 passes. At this time, the medium P2 is already transported from the separator 164 by the additional transport amount in conjunction with the transport of the medium P1.

Specifically, the separator 164 and the second transport unit 122 are controlled as follows according to a time when the sensing units 171 and 172 sense the medium P1.

From a time point at which the sensing unit 171 senses the medium P1, the separator 164 transports the medium P1 by an amount obtained by subtracting the length from the separator 164 to the sensing unit 171 along the transport direction from the length of the medium P1 and adding the additional transport amount, and temporarily stops.

From a time point at which the sensing unit 172 senses the medium P1, the second transport unit 122 transports the medium P1 by an amount obtained by adding a loop amount to a length from the sensing unit 172 to the first transport unit 121 along the transport direction, and temporarily stops. This transport is referred to as primary paper feeding, and transport for feeding the medium P1 toward the platen after the primary paper feeding is referred to as secondary paper feeding.

Here, the loop amount is a transport amount for abutting the medium P1 against the first transport unit 121 to eliminate skew or curving of the medium P1. The loop amount can be changed as appropriate. The additional transport amount is preferably equal to or larger than the loop amount. When the loop amount is larger than the additional transport amount, the medium P1 abuts against the first transport unit 121 in a state of being applied with the back tension, and it is less likely to eliminate the skew or curving.

In the method for controlling the medium transport device 200, when the length of the medium P1 is the same as or close to the distance from the first transport unit 121 to the separator 164 along the transport direction, a trailing end of the preceding medium P1 and a leading end of the subsequent medium P2 collide with each other. Specifically, when the length of the medium P1 is the same as the distance from the first transport unit 121 to the separator 164 along the transport direction, the separator 164 performs a transport operation by the above-described additional transport amount from a time when the medium P1 abuts against the first transport unit 121.

At this time, the second transport unit 122 performs the transport operation by the loop amount. Since the additional transport amount is larger than the loop amount, in time series, the second transport unit 122 stops first, and the transport of the medium P1 stops. In contrast, even when the second transport unit 122 stops, the subsequent medium P2 is fed because the separator 164 continues the transport. Therefore, the trailing end of the medium P1, which is stopped transporting, and the leading end of the medium P2 collide with each other. The collision between the medium P1 and the medium P2 may cause bending or damage to end portions of the media P1 and P2, and may trigger a paper jam determination due to the bending.

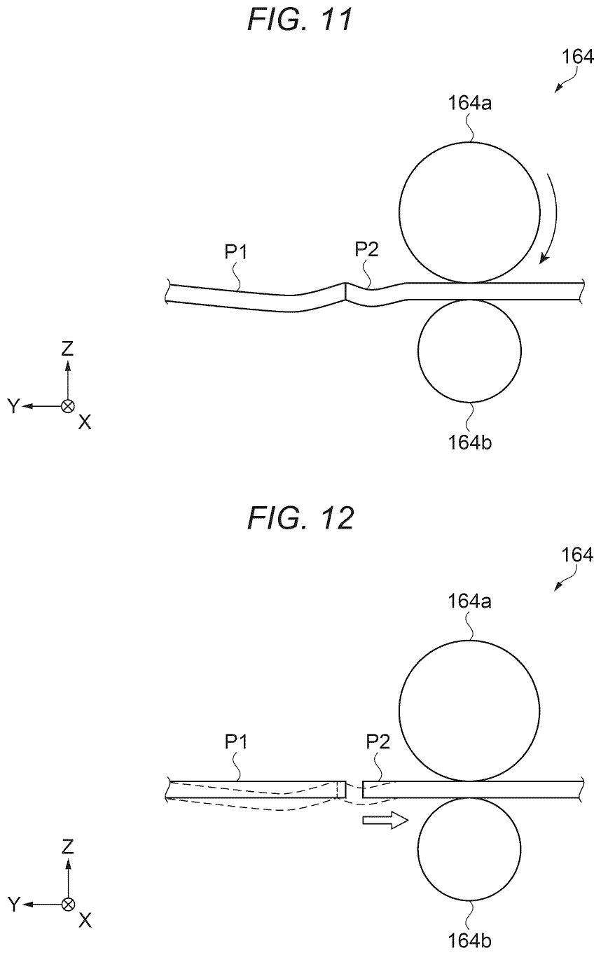

Specifically, as illustrated in FIG. 11, when the medium P1 and the medium P2 collide with each other with force, the periphery of each end portion bends. As described above, the feeding part 164a includes the switching unit, which is a clutch mechanism. Therefore, when the driving is stopped, the clutch mechanism of the switching unit is brought into the disengaged state, and the feeding part 164a rotates freely.

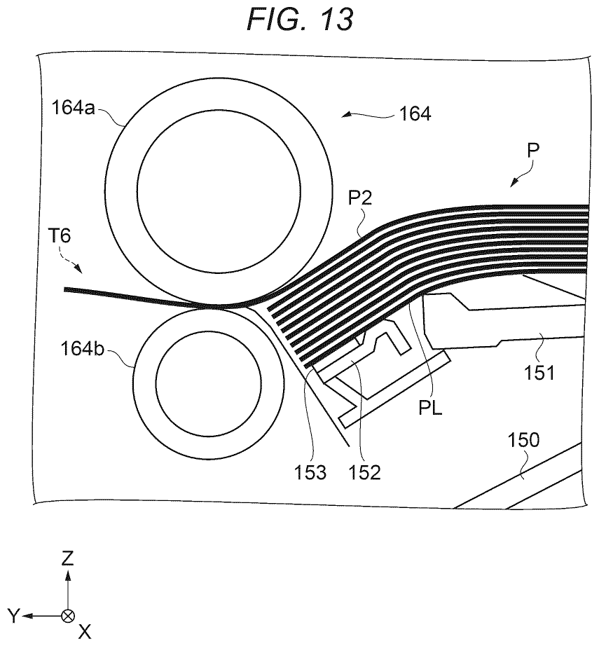

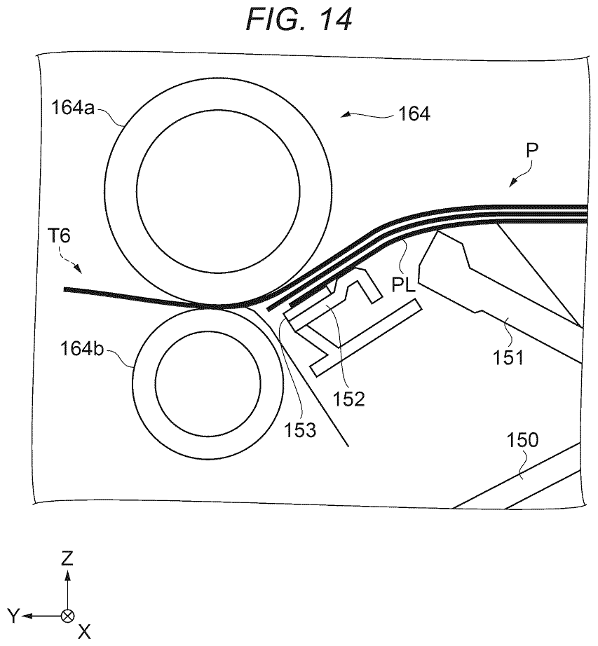

Therefore, as illustrated in FIG. 12, the medium P2 is greatly returned toward a separator 164 side, which is the upstream side, by a reaction force for eliminating the generated bending. At this time, the hopper 152 in contact with the feeding part 164a via the medium P vibrates relatively greatly. At the same time, as illustrated in FIG. 13, a position of the bundle of media P is shifted substantially in the −Y direction along with the movement of the medium P2. Then, when the uppermost medium P in the bundle of media P is subsequently fed, the bundle of media P is pulled by the fed upper medium P and tries to return to the normal position. However, since a lowermost medium PL in the bundle of media P is in contact with the friction member 153, the medium PL cannot follow the movement of the bundle of media P and stays at a position illustrated in FIG. 13.

When the above-described collision between the media P and the restart of paper feeding are repeated, a leading end of the lowermost medium PL is significantly displaced from the position of the leading end of the bundle of media P, as illustrated in FIG. 14. Accordingly, the medium PL deviates from a contact position with the feeding part 164a, a transport failure occurs, and a paper jam is determined.

To solve the above problem, for example, when the medium P1 is transported in the primary paper feeding, a countermeasure is considered in which the transport of the medium P1 by the additional transport amount is stopped, and control is performed such that the medium P1 does not completely pass through the separator 164. In this case, the preceding medium P1 and the subsequent medium P2 do not collide with each other, and the medium P1 is in a state of being sandwiched by the separator 164. At this time, the back tension is applied to the medium P1. In this case, a transport force of the second transport unit 122 needs to exceed the back tension. However, since the rotating body 122a is a knurled roller, the protrusions of the rotating body 122a may damage the medium P1 when the transport force is increased.

In addition, for example, it is conceivable to perform control of rotationally driving the feeding part 164a to feed the medium P1 during the secondary paper feeding. In this case, it is necessary to set a driving time of the feeding part 164a to be short to prevent the subsequent medium P2 from being excessively fed to the path T6 and to prevent a paper jam from being determined. However, since the switching unit provided in the separator 164 has a restriction on a minimum coupling time, the medium P2 may be excessively fed even with a lower limit driving time.

For example, at a time point at which the medium P2 reaches the separator 164, it is conceivable to perform control in which the hopper 152 is in the lowered state and the medium P2 and the feeding part 164a are separated from each other. Accordingly, in the primary paper feeding of the medium P1, the leading end of the medium P2 is not fed from the separator 164, and the medium P1 and the medium P2 do not collide with each other. However, since the hopper 152 is lowered and raised between the primary paper feeding and the secondary paper feeding, the time required for the transport may increase. When a vertical operation of the hopper 152 is performed in a short time to reduce the time described above, an operating noise may increase. In addition, when the vertical operation is performed at a high speed, the above-described positional deviation of the bundle of media P is likely to deteriorate.

For example, a countermeasure of extending the path T3 to increase a distance until the medium P1 and the medium P2 collide with each other is considered, but the medium transport device 200 may increase in size.

The medium transport device 100 according to the embodiment prevents the occurrence of the above-described problems. Hereinafter, a method for controlling the transport of the medium P in the medium transport device 100 will be described.

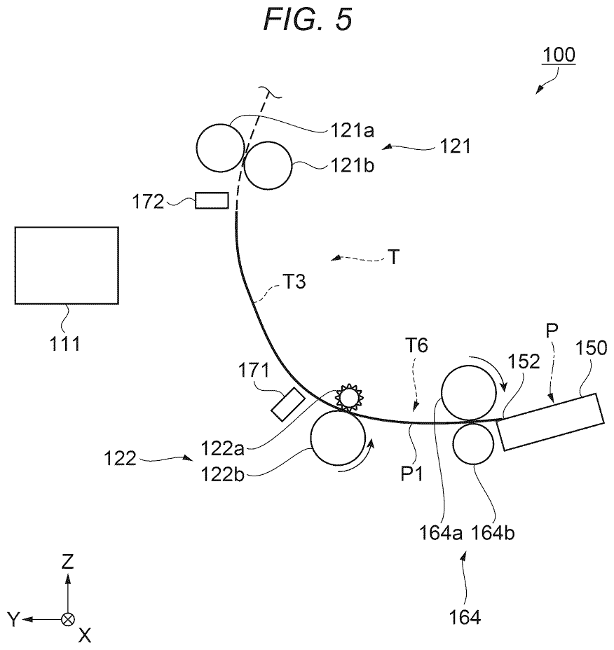

As illustrated in FIG. 5, in the primary paper feeding, when the medium P including the media P1 and P2 is transported from the paper feed tray 150 to the first transport unit 121, the control unit 111 rotationally drives the feeding part 164a and the transport roller 122b.

Here, when the length of the medium P is a first length, the control unit 111 executes first separation control based on the first length. In the first separation control, the feeding part 164a is driven at the same speed as the transport roller 122b of the second transport unit 122. Being based on the first length is not limited to executing the first separation control by the first length. That is, the first separation control may be determined according to the first length. As described above, the length including the first length of the medium P is transmitted from the length detection unit to the control unit 111.

Specifically, the first separation control is executed until the trailing end of the medium P1 passes through the separator 164 completely. The control unit 111 measures the time when the trailing end of the medium P1 passes through the separator 164 completely according to the first length.

Alternatively, the control unit 111 may execute the first separation control based on the length of the medium P1 and the distance along the transport direction from the separator 164 to the sensing unit 171 after the sensing unit 171 senses the leading end of the medium P1. At this time, the control unit 111 transports the medium P1 by a distance obtained by subtracting the distance along the transport direction between the separator 164 and the sensing unit 171 from the length of the medium P1. Accordingly, by sensing the leading end of the medium P1, it is possible to predict the time when the trailing end of the medium P1 passes through the separator 164. Therefore, accuracy of control for ending the first separation control can be improved.

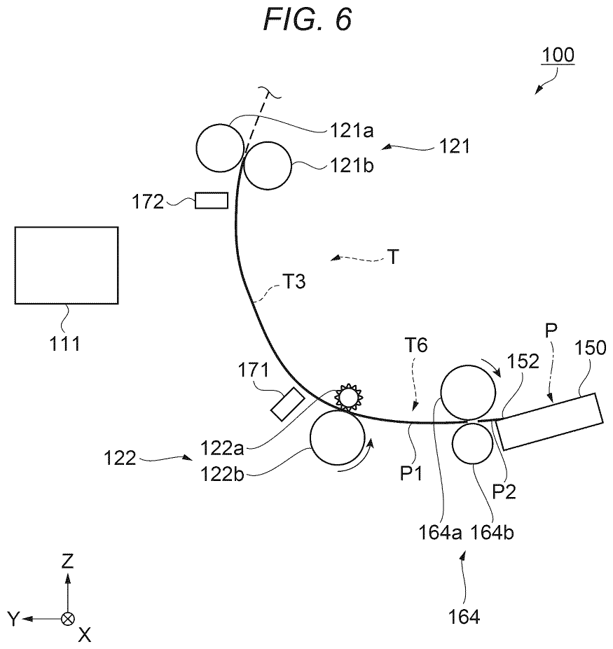

Next, as illustrated in FIG. 6, when the trailing end of the medium P1 completely passes through the separator 164, the control unit 111 executes second separation control subsequently to the first separation control. In the second separation control, the feeding part 164a is driven at a speed less than that of the transport roller 122b of the second transport unit 122.

As described above, the transport roller 122b is driven by the first drive unit, and the feeding part 164a is driven by the second drive unit. Accordingly, a rotation speed of the feeding part 164a in the second separation control is less than a rotation speed of the feeding part 164a in the first separation control. That is, in the second separation control, the rotation speed of the feeding part 164a is lowered without changing the rotation speed of the transport roller 122b as compared with the first separation control. In the second separation control, the separator 164 transports the medium P1 by the above-described additional transport amount. After executing the second separation control, the control unit 111 stops the transport of the medium P1. The above is the primary paper feeding in the medium transport device 100.

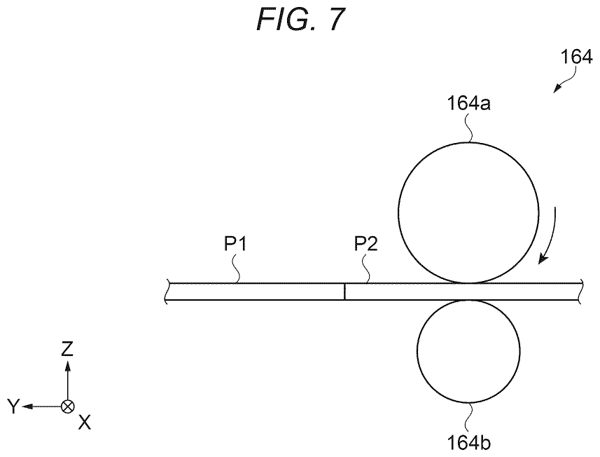

By executing the second separation control after the first separation control, as illustrated in FIG. 7, a momentum of collision between the trailing end of the medium P1 and the leading end of the medium P2 is prevented. That is, even when the medium P1 and the medium P2 abut against each other, the medium P1 and the medium P2 abut against each other relatively slowly. Therefore, the media P1 and P2 are less likely to be bent or damaged. In addition, paper jam determination due to the bending is less likely to be induced.

Here, the control unit 111 may execute the following control in the second separation control. That is, the control unit 111 causes the second transport unit 122 to form a loop in a region including the leading end of the medium P1 from a state where the leading end of the medium P1 abuts against the first transport unit 121 that stops transporting. A transport amount of the medium P1 in the second separation control, that is, the additional transport amount is equal to or larger than a transport amount of the medium P1 when the loop is formed, that is, the loop amount.

Accordingly, the additional transport amount, which is the transport amount of the medium P1 in the second separation control, is larger than the loop amount. Therefore, it is possible to prevent back tension from being applied from the separator 164 to the medium P1 when the loop is formed. Accordingly, when the loop is formed, it is possible to prevent the sandwiching of the medium P1 by the separator 164 from becoming a load of the transport of the second transport unit 122.

The control unit 111 may execute the first separation control and the second separation control when transporting the medium P1 having a length along the transport direction less than the distance along the transport direction from the separator 164 to the first transport unit 121.

Accordingly, the number of types of applicable media P1 increases, and usability is improved. In the medium P1 having a length less than the distance from the separator 164 to the first transport unit 121, the first separation control and the second separation control are performed to prevent the collision between the medium P1 and the medium P2. In the medium P1 having a length equal to or larger than the distance described above, the second separation control is not necessarily performed after the first separation control. That is, the second separation control is performed only on the medium P having a concern about collision between the media P, and is omitted for the medium P having no concern described above. Therefore, compared to a case where the second separation control is uniformly performed, it is possible to prevent a decrease in throughput due to the low-speed transport in the second separation control. In this case, a predetermined amount of additional transport may be performed in the first separation control.

In the medium transport device 100, when a plurality of media P are continuously supplied, the raised state of the hopper 152 is maintained. By not setting the hopper 152 to the lowered state during continuous paper feeding, an operation sound accompanying switching between the raised state and the lowered state is not generated, and noise can be reduced. It is possible to prevent the occurrence of positional deviation caused by the vertical movement of the hopper 152 in the bundle of media P placed in the paper feed tray 150. Since the hopper 152 is not brought into the lowered state for each sheet of the media P, it is possible to supply the medium P at a relatively high speed compared to a case where the hopper 152 is switched to the lowered state each time. In addition, even when feeding paper at a high speed continuously, the collision between the media P is prevented by the second separation control.

After executing the second separation control, the control unit 111 sets the switching unit into the disengaged state. Accordingly, by setting the switching unit to the disengaged state after the second separation control, it is possible to cut a rotational driving force to the feeding part 164a and to stop the transport of the subsequent medium P2 in the separator 164.

In the related art, the trailing end of the preceding medium P1 fed from the separator 164 and the leading end of the subsequent medium P2 to be fed from the separator 164 may collide with each other, and the media P1 and P2 may be bent. In such a case, when the driving of the feeding part 164a is in the disengaged state, the subsequent medium P2 may retreat to eliminate the bending due to the reaction force of the bending, and the position of the bundle of media P placed on the paper feed tray 150 may deviate. When the positional deviation of the bundle of media P is accumulated, the medium P may not be supplied from the paper feed tray 150. In contrast, since it is possible to prevent the collision between the medium P1 and the medium P2 and to alleviate the impact when the medium P1 and the medium P2 come into contact with each other, it is possible to prevent the occurrence of the bending and to prevent the occurrence of the positional deviation of the subsequent medium P2 or the bundle of media P.

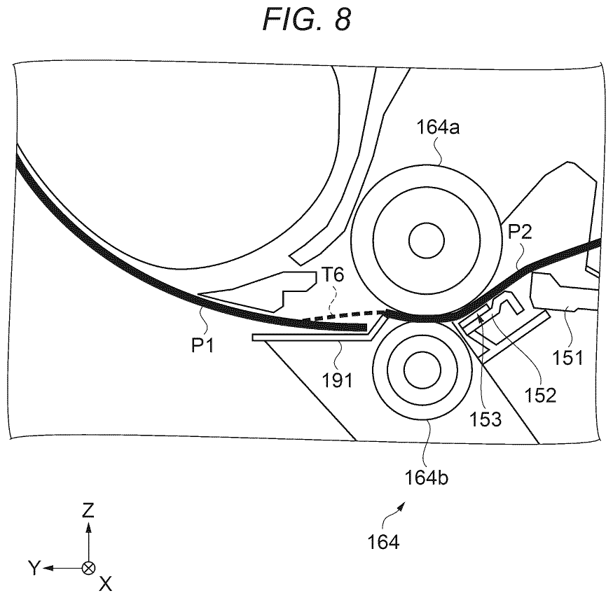

Here, as illustrated in FIG. 8, the medium transport device 100 may include a step member 191. The step member 191 prevents collision between the trailing end of the medium P1 and the leading end of the medium P2.

The step member 191 is disposed below the feeding part 164a in the +Y direction. The step member 191 guides a trajectory of the trailing end of the medium P1 to be lower than the path T6 when the medium P1 completely passes through the separator 164 and is fed.

Specifically, in the above-described configuration in which the step member 191 is not provided, when the medium P1 is fed from the separator 164, the medium P1 is transported along the path T6 indicated by a broken line. In the configuration described above, a guide member is disposed such that the medium P including the media P1 and P2 travels along the path T6. The step member 191 replaces the guide member.

When the step member 191 is disposed, the leading end of the medium P1 fed from the separator 164 moves along a trajectory close to the path T6, and the trailing end of the medium P1 hangs down to come into contact with the step member 191. This is because the medium P1 is transported while being curved from the separator 164. The trailing end of the medium P1 falls downward due to an action of reducing the curvature of the medium P1 itself and gravity.

Then, when the leading end of the subsequent medium P2 is fed following the medium P1, the leading end of the medium P2 moves along a trajectory close to the path T6. Since a height difference occurs between the trailing end of the medium P1 and the leading end of the medium P2, it is possible to avoid collision.

In the embodiment, the medium transport device 100 corresponding to the paper feed tray 150 is exemplified, but the present disclosure is not limited thereto. The medium transport device according to the present disclosure may be applied to, for example, a device that transports the medium P from the paper cassette unit 16 housed in the main body unit 12 or the like.

According to the embodiment, the following effects can be obtained.

It is possible to prevent the occurrence of damage to the medium P. Specifically, the transport speed of the medium P by the feeding part 164a is controlled according to the length of the medium P. Therefore, in the separator 164, after the preceding medium P1 is transported in the first separation control, the subsequent medium P2 can be transported in the second separation control. Accordingly, when the subsequent medium P2 is transported downstream after the preceding medium P1 passes through the separator 164, it is possible to prevent the collision between the trailing end of the preceding medium P1 and the leading end of the subsequent medium P2 and to alleviate the impact when the preceding medium P1 and the subsequent medium P2 come into contact with each other. Therefore, it is possible to provide the medium transport device 100 and the recording apparatus 1 that prevent the occurrence of damage to the medium P.

Since the collision between the media P is prevented, the bending of the medium P due to the collision is prevented. Accordingly, it is possible to prevent the occurrence of the transport failure caused by the bending of the medium P.

It is possible to reduce the transport load of the second transport unit 122. Specifically, the transport of the medium P is controlled according to the length of the medium P, enabling the trailing end of the medium P to reliably pass through the separator 164. When the transport of the medium P is temporarily stopped by skew correction or the like, when the trailing end of the medium P does not completely pass through the separator 164, the medium P is stopped in a state where the trailing end of the medium P is sandwiched by the separator 164. When the second transport unit 122 resumes the transport of the medium P from the state described above, a load is applied to the second transport unit 122 to pull out the sandwiched medium P from the separator 164. In contrast, when the transport of the medium P is temporarily stopped, it is also possible to cause the medium P to pass through the separator 164 such that the trailing end of the medium P is not sandwiched by the separator 164. Accordingly, it is possible to avoid the back tension from being applied to the medium P from the separator 164, and to reduce the load of the transport of the second transport unit 122 when the transport of the medium P is resumed from a stop state.

In the related art, when the bending of the medium P caused by the contact between the media P is eliminated, the position of the bundle of media P placed in the paper feed tray 150 may slightly deviate in a retreating direction. In this case, when the supply of the medium P from the paper feed tray 150 is resumed, the bundle of media P is dragged by the uppermost medium P in contact with the feeding part 164a in the bundle of media P, and the bundle of media P slightly advances in a direction approaching the feeding part 164a and returns. At this time, since the lowermost medium PL in the bundle of media P is in contact with the friction member 153, the lowermost medium PL may remain at a position deviated rearward from the bundle of media P without moving forward together with the bundle of media P. When the backward movement and the forward movement of the bundle of media P are repeated, the positional deviation between the bundle of media P and the lowermost medium PL may increase, and a problem may occur in the supply of the medium P. In contrast, since it is possible to prevent the collision between the media P and alleviate the impact when the media P comes into contact with each other, it is possible to prevent the occurrence of the bending and to prevent the occurrence of the positional deviation between the bundle of media P and the lowermost medium PL.

In the related art, the transport of the medium P may be temporarily stopped in a state where the separator 164 sandwiches the medium P. In order for the second transport unit 122 to resume the transport of the medium P from the state described above, it is necessary to increase the transport force of the second transport unit 122 to pull out the sandwiched medium P from the separator 164. Therefore, when a force of the second transport unit 122 for sandwiching the medium P is increased, the protrusions of the rotating body 122a are relatively strongly abutted against the medium P, and a contact mark may be formed on the medium P. In contrast, the transport of the medium P is controlled according to the length of the medium P, enabling the trailing end of the medium P to reliably pass through the separator 164. That is, since a situation in which the second transport unit 122 pulls out the medium P sandwiched by the separator 164 does not occur and it is not necessary to increase the transport force of the second transport unit 122, it is possible to prevent the occurrence of the contact mark on the medium P.

What is claimed is:

1. A medium transport device comprising:
a separator configured to separate a medium;
a first transport unit located downstream of the separator in a transport direction of the medium and configured to transport and stop the medium;
a second transport unit located between the separator and the first transport unit in the transport direction and configured to transport the medium to the first transport unit;
a control unit configured to control the separator and the second transport unit; and
a length detection unit configured to detect a length of the medium along the transport direction, wherein
the separator includes
a feeding part configured to transport the medium in the transport direction, and
a separation member configured to separate the medium by sandwiching the medium together with the feeding part, and
when the length of the medium is a first length, the control unit executes first separation control of driving the feeding part at a same speed as a speed of the second transport unit based on the first length, and executes second separation control of driving the feeding part at a speed less than the speed of the second transport unit subsequently to the first separation control.

2. The medium transport device according to claim 1, further comprising:
a first drive unit configured to drive the first transport unit and the second transport unit; and
a second drive unit configured to drive the feeding part.

3. The medium transport device according to claim 1, further comprising:
a sensing unit configured to sense the medium downstream of the second transport unit in the transport direction, wherein
the control unit executes the first separation control based on the length of the medium and a distance from the separator to the sensing unit after the sensing unit senses a leading end of the medium.

4. The medium transport device according to claim 1, wherein
the second transport unit forms a loop on the medium from a state where a leading end of the medium abuts against the first transport unit that stops transporting, and
a transport amount of the medium in the second separation control is equal to or larger than a transport amount of the medium when the loop is formed.

5. The medium transport device according to claim 1, wherein
a minimum value of the length of the medium that is capable of being transported is less than a distance from the separator to the first transport unit.

6. The medium transport device according to claim 5, wherein
when transporting the medium having the length less than the distance from the separator to the first transport unit, the first separation control and the second separation control are performed.

7. The medium transport device according to claim 1, wherein
the separation member is a separation roller configured to switch between a driven state of being driven to rotate with respect to the feeding part and a separation state of rotating in a reverse direction.

8. The medium transport device according to claim 1, further comprising:
a placement unit configured to allow the medium to be placed therein; and
a hopper configured to switch between a raised state and a lowered state, lift the medium from the placement unit in the raised state, and bring the medium into contact with the feeding part, wherein
the raised state is maintained when a plurality of the media are continuously supplied.

9. The medium transport device according to claim 1, wherein
the separator further includes a switching unit configured to switch between a driving state of driving the feeding part to rotate, and a disengaged state in which the feeding part is driven to rotate, and
the control unit sets the switching unit to the disengaged state after executing the second separation control.

10. The medium transport device according to claim 9, further comprising:
a placement unit configured to allow the medium to be placed therein; and
a hopper configured to lift the medium from the placement unit and bring the medium into contact with the feeding part, wherein
the hopper includes a friction member at a position facing the feeding part.

11. A recording apparatus comprising:
the medium transport device according to claim 1; and
a recording unit configured to perform recording on the medium transported by the medium transport device.

12. The recording apparatus according to claim 11, wherein
the recording unit performs the recording by discharging a liquid onto the medium, and
the second transport unit includes a rotating body including a protrusion protruding toward the medium.
